(19) United States
(12) Patent Application Publication
(10) Pub. No.: US 2015/0279246 A1
(43) Pub. Date: Oct. 1, 2015

(54) Printable Adhesive and Label Assembly

(71) Applicant: Avery Dennison Corporation, Glendale, CA (US)

(72) Inventors: Eric L. BARTHOLOMEW, Mill Hall, PA (US); Sudhir HUBLIKAR, Chagrin Falls, OH (US); Michael T. WATERMAN, Chardon, OH (US); Michael ZAJACZKOWSKI, Bellefonte, PA (US)

(21) Appl. No.: 14/674,883

(22) Filed: Mar. 31, 2015

Related U.S. Application Data
(60) Provisional application No. 61/972,508, filed on Mar. 31, 2014.

(51) Int. Cl. G09F 3/10; B32B 37/12; B65C 3/26; B65C 9/25; B65C 3/06; B32B 37/18; B32B 38/00

(52) U.S. Cl. CPC G09F 3/10; B32B 37/18; B32B 37/1284; B32B 38/0008; B65C 9/25; B65C 3/06; B65C 3/26; B32B 2037/1253; B32B 2519/00

(57) ABSTRACT

Radiation curable adhesives compositions and label assemblies are described which can be used in various labeling systems and methods. The adhesive compositions may be curable by exposure to UV radiation and are incorporated in the label assemblies. In certain versions, the label assemblies are free of liners otherwise covering the adhesive.

### CROSS-REFERENCE TO RELATED APPLICATION

The present application claims the benefit of U.S. Provisional Application No. 61/972,508 filed Mar. 31, 2014, which is incorporated herein by reference in its entirety.

### FIELD

The present subject matter relates generally to printable adhesives, label assemblies, labeling systems and related methods for applying labels to containers, and more particularly to printable adhesives and label assemblies employing radiation curable adhesives for adhering a label to a container. The labels employable in this subject matter are in the form of plastic, sheet fed/cut and stack labels, and can be formed of films that are transparent or opaque, including metallized films. Particularly, the radiation curable adhesive is a UV curable adhesive but can also be curable by other means, e.g., electron beam and radio frequency radiation.

### BACKGROUND

A variety of labeling systems are known for applying labels to containers. These systems employ either continuous roll fed labels or cut and stack labels.

Previous labeling systems and methods utilizing labels in continuous roll form include label cutting and registration equipment for severing discrete labels from a roll and then registering them for attachment to containers through a vacuum transfer drive system. In such systems, a hot melt adhesive typically is used. The adhesive is applied to both a leading edge and a trailing edge of the back side of the labels which enables attachment of the labels to the containers.

Although the previously noted system has been used commercially, it suffers from a number of drawbacks. One disadvantage is that continuous roll fed labeling systems require both label cutting and registration units, which increase the complexity of the system. Another disadvantage relates to the adhesive. Hot melt adhesives are typically cloudy or milky in appearance and therefore are not desired for applying clear or transparent labels in a uniform fashion to clear containers. Applying clear or transparent labels to clear containers, e.g., clear glass or plastic beer and soda bottles, is very desirable, as such affixment provides a clean finish, and also enables the product inside of the container to be clearly and easily viewed through the label. Another disadvantage associated with hot melt adhesives is that typically they are difficult to apply as a smooth, continuous layer to label stock.

It is also known to employ continuous rolls of transparent pressure sensitive labels for application to clear containers. However, as previously noted, the use of such continuous rolls require cutting and registration units that increase the complexity of the labeling system. In addition, the rolls of pressure sensitive labels often include a release liner covering the adhesive surface, thereby necessitating the removal of the release liner from the label during the continuous process. This additional operation introduces an undesired complexity and cost into the labeling process and equipment.

It also is known to apply sheet fed/cut and stack labels. The term “cut and stack” labels refers to labels that have been cut off line and are retained in a stack within a dispensing magazine. Typically, such labels are applied to containers, such as bottles, in a continuous label application system. Cut and stack labeling systems often employ a cold glue adhesive, which is water soluble, and sometimes employ a hot melt adhesive. When a cold glue adhesive is used, the adhesive is applied to a glue transfer pad by a transfer roll that is typically formed from steel, and then the glue transfer pad is contacted with a label at the bottom of the stack to thereby apply the glue to that label and remove the label from the stack through surface adhesion between the label and the adhesive. Then, the label, with a layer of the cold glue adhesive, is moved to a transfer drum, from where it is then applied to a container, such as a glass bottle. Cold glue adhesives have typically been utilized only in association with paper labels that are capable of absorbing water from the adhesives. Systems employing water soluble cold glue adhesives are not well suited for use with non-porous, plastic labels. Although hot melt adhesives also have been employed with cut and stack labels, such adhesives are subject to the same deficiencies previously noted with respect to the use of such adhesives on continuous label stock.

Accordingly, a need exists for printable adhesives, label assemblies using such adhesives, and associated labeling systems and methods that can be used with plastic labels for adhering such labels to containers. More particularly, a need exists in providing a printable adhesive and associated labels that can be used in conjunction with clear containers, such as clear glass bottles, e.g., beer or soda bottles, without the presence of unsightly striations or other unsightly imperfections in the adhesive distribution. In addition, a need exists for such adhesives and labels that do not require the use of label cutting and registration units of the type generally employed in labeling systems and methods that handle continuous roll fed labels.

### SUMMARY

The difficulties and drawbacks associated with previously known systems and practices are addressed in the present adhesives and label assemblies.

In one aspect of the present subject matter, a label assembly is provided. The label assembly comprises a substrate defining a first face and a second oppositely directed face. The label assembly also comprises a layer of a thiol-ene adhesive disposed on at least one of the first face and the second face of the substrate.

In another aspect of the present subject matter, a method of labeling is provided. The method comprises providing a surface to receive a label substrate that defines a first face and an oppositely directed second face. The method also comprises applying a thiol-ene adhesive to the first face of the label substrate to thereby form an adhesive layer on the label substrate. The adhesive layer defines an exposed adhesive face. The method also comprises contacting the adhesive face with the surface and adhering the label substrate to the surface.

In yet another aspect of the present subject matter, a method of labeling a surface is provided. The method comprises providing a surface to receive a label. The method also comprises providing a label substrate which defines a first face and an oppositely directed second face. The method also comprises applying a thiol-ene adhesive to the first face of the label substrate to thereby form an adhesive layer on the label substrate. The adhesive layer defines an exposed adhesive face. The method also comprises at least partially curing the adhesive. And, the method comprises contacting the adhesive face after at least partially curing, with the surface. The method also comprises adhering the label substrate to the surface.

As will be realized, the subject matter described herein is capable of other and different embodiments and its several details are capable of modifications in various respects, all without departing from the claimed subject matter. Accordingly, the drawings and description are to be regarded as illustrative and not restrictive.

### BRIEF DESCRIPTION OF THE DRAWINGS

FIG. 1 illustrates a schematic cross sectional view of a label assembly in accordance with the present subject matter.

FIG. 2 is a schematic perspective view of another label assembly in accordance with the present subject matter.

FIG. 3 is a schematic view illustrating an embodiment of a method and system of the present subject matter.

FIG. 4 is a schematic perspective view of a portion of an adhesive application station in which a UV curable adhesive is transferred to an exposed surface of a rotating transfer pad, prior to the transfer pad being directed into a transfer station for receiving a label thereon.

FIG. 5 is a schematic perspective view illustrating engagement of a rotating transfer pad with UV curable adhesive thereon with the lowermost label in a stack of such labels.

FIG. 6 is a schematic perspective view illustrating retention of a label on a transfer assembly that directs the label through a UV cure station and then to a label application station.

FIG. 7 is a schematic flow chart of a method in accordance with the present subject matter.

FIG. 8 is a schematic flow chart of another method in accordance with the present subject matter.

### DETAILED DESCRIPTION OF THE EMBODIMENTS

The present subject matter provides adhesives which can be printed or otherwise applied to a variety of surfaces and substrates. The adhesives are radiation curable. The present subject matter also relates to various label assemblies that include or utilize the radiation curable adhesives. In many embodiments, the label assemblies are free of release liners, and thus are “linerless.” The present subject matter additionally relates to labeling systems and associated methods utilizing the adhesives and label assemblies.

A radiation curable adhesive, which is not excessively tacky prior to curing or partial curing, is applied to the surface of a label to be attached to a container. The label, with the radiation curable adhesive thereon, optionally is fed through a curing operation to enhance the tack of the adhesive prior to adhering the label to a container. The label and adhesive are then fed to a station for applying the label to a surface of the container via the adhesive on the label. After label application, post curing of the adhesive with radiation may be performed. In certain embodiments, the present subject matter omits a curing or partial curing operation of the adhesive prior to applying the label onto a surface of a container. In this aspect of the present subject matter, the radiation curable adhesive is sufficiently tacky to adhere the label to the container without any radiation curing operation. After the label is adhered to the container through the uncured adhesive, the adhesive is exposed to radiation to enhance, or provide the desired curing of the adhesive.

In accordance with another aspect of the present subject matter, the adhesive can in certain embodiments, be subjected to radiation to either fully or partially cure the adhesive on the label prior to applying the label to a container. The radiation exposure operation can be carried out in at least two different stages, e.g., at different spectra of radiation. This strategy may be utilized to target the curing of the adhesive in different regions through the thickness of the adhesive layer. In certain embodiments, the curing operation is performed in two or more stages. A first stage may utilize radiation at a longer wavelength radiation than that used in a second stage to primarily cure or partially cure interior regions of the adhesive layer. Thus, the second stage utilizes a shorter wavelength radiation than the first stage to primarily cure or partially cure the exposed surface region of the adhesive layer. In certain embodiments, the radiation curable adhesive is a UV curable adhesive and the two different spectra of radiation are provided by different light sources having different UV radiation frequencies or wavelengths.

The present subject matter includes curing the adhesive to a full pressure sensitive state in the curing operation. In this condition, additional curing of the adhesive after the label is applied to the container is typically not employed. The adhesive is sufficiently tacky to ensure that the label remains permanently adhered to the container during normal handling of the container. It also is within the scope of the present subject matter to only partially cure the adhesive in the radiation curing operation(s) to render the adhesive sufficiently tacky to initially adhere the label to a container. However, thereafter the adhesive will continue to cure, or otherwise polymerize, to ensure that the label remains permanently adhered to the container during typical handling of the container. Moreover, as previously noted, additional radiation can be applied to the adhesive after the label is adhered to the container to increase the rate and/or extent of curing. When such an additional radiation step is utilized, the curing step prior to label application to the container may potentially be performed using a single wavelength range.

In accordance with the present subject matter, the radiation curable adhesive is typically curable with ultraviolet radiation, although it is within the scope of the broadest aspects of the present subject matter to employ other types of radiation curable adhesives, such as adhesives curable by radio frequency radiation and electron beam radiation. The adhesives typically used in the present subject matter should have a sufficiently low viscosity to permit them to be applied by an adhesive applicator roll to outer surfaces of transfer pads or other component(s) on a rotating support member for subsequent application from the transfer pads substantially continuously and uniformly to the surface of a label to be adhered to a container. When the label is a cut and stack label, the adhesive also needs to have a sufficient initial tack herein sometimes referred to as “minimal tack”, to permit the transfer pads, with the adhesive on the surface thereof, to remove the lowermost label from a stack of such labels retained within a magazine at the time that the adhesive also is being applied to that label by a transfer pad. This initial or minimal tack should not be so strong as to preclude peeling the label from the transfer pad at a subsequent station at which the adhesive on the label is at least partially cured, in a manner to be further explained herein, or alternatively at which it is directly applied to a container without an additional curing step. In this latter case, the adhesive is exposed to a curing operation after the label is adhered to the container, and in the former case it is within the scope of the present subject matter, although not required, to expose the adhesive to a further curing operation after the label is adhered to the container.

More particularly, when the labels are transparent and are adhered to clear containers, the adhesive is a UV curable adhesive that has the ability to cold flow after application of the label to the bottle, either when the adhesive is partially cured prior to applying the label to the bottle or when the entire extent of curing is carried out after the label is applied to the container. This ability to cold flow at least reduces the potential for the existence of unsightly adhesive striations between the label and container.

In certain embodiments, when transparent labels are being utilized in accordance with the present subject matter, the UV curable adhesive is applied with a coat weight of at least 6 pounds per ream and more particularly in a weight range of 7 to 8 pounds per ream, or greater. Generally, the adhesive is applied to the label at a sufficient thickness to enable the adhesive to cold flow after the label is applied to the container, regardless of whether the adhesive is partially cured prior to application of the label to the bottle, and thereby fill in unsightly striations that often are formed in the adhesive between the label and the container. In certain embodiments, an adhesive thickness in the range of about 0.5 to about 1.0 mils can be used, with the thickness generally not exceeding 1.5 mils. Specifically, an adhesive thickness in the range of about 0.5 to about 1.0 mils tends to cold flow after application of the label to the container, to fill in unsightly striations and other visual defects in the adhesive layer.

In certain embodiments of the present subject matter, the labels are individual, cut and stack labels retained in a magazine, and a UV curable adhesive is applied to a lower surface of each label in the stack through a rotating transfer pad that moves sequentially through an adhesive application station in which a measured quantity of UV curable adhesive is transferred to the exposed surface of the pad, and then to a transfer station. The adhesive on the exposed surface of the pad contacts the lowermost label in the stack to both apply the adhesive to that label and remove the label from the stack through the surface adhesion created between the label surface and the minimal tack of the uncured UV curable adhesive. The terms “minimal tack” or “minimally tacky” refers to a tacky condition that is sufficient to engage and remove the lowermost label from a stack of cut and stack labels retained in a magazine, but which is not so strong as to either preclude peeling of the label off of the transfer pad at a subsequent cure station, or to permit the uncured adhesive to consistently, reliably and effectively permanently adhere the label to a container in a commercial labeling system and method. The terms “effectively permanently adhered” or “effective permanent adherence,” refers to a label being secured to a container in a manner that precludes the edge regions or body thereof from unacceptably separating from the container wall during handling and use of the container, and particularly, although not required within the broadest aspects of the present subject matter, in a manner that prevents an individual from easily peeling the label off of the container.

In accordance with the present subject matter, the effective permanent adherence of the label to the container is obtained either by multi-stage, and particularly two stage, radiation of the adhesive prior to adhering the label to the container, as described herein, either with or without a subsequent cure or radiation step after adherence of the label to the container; solely by post radiation curing of the adhesive after the label initially has been applied to the container without any prior radiation treatment to cure or partially cure the adhesive prior to application of the label to the container, or by single stage radiation of the adhesive prior to adhering the label to the container, as described herein, with a subsequent cure or radiation step after adherence of the label to the container.

In certain embodiments of the present subject matter, the UV curable adhesive comprises one or more free radical and/or cationic initiators and monomers that are polymerizable by these mechanisms, and is capable of flowing while curing on a container to fill in imperfections, e.g., striations, in the initial distribution of the adhesive on the label.

In certain embodiments of the present subject matter, the individual labels carried on the transfer pads are then directed to a transfer assembly, wherein the individual labels, with the minimally tacky, UV curable adhesive applied thereto, are released from the pads and directed by the transfer assembly through a UV cure station in which the UV curable adhesive is cured, preferably by the previously noted two stage radiation treatment, o render the adhesive sufficiently tacky to permit the label to be reliably and effectively adhered to a surface of a container, and then into a label application station for transferring each individual label, with the sufficiently tacky adhesive thereon, to the outer surface of a container, typically a glass container, such as a beer or soda bottle, to thereby effectively adhere the label to the container.

Having described various aspects of the present subject matter and its numerous embodiments, description is now provided of specific aspects and details of the present subject matter.

### Label Assemblies

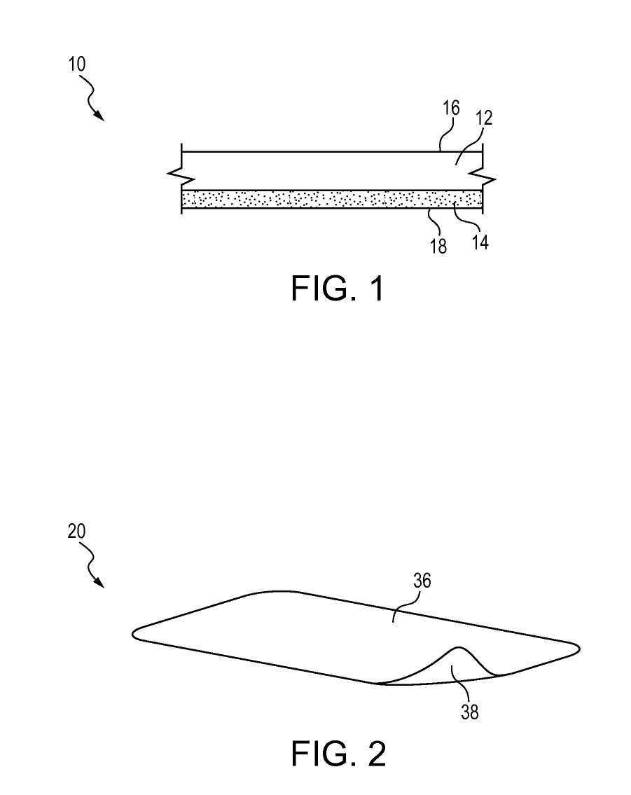

Referring to FIG. 1, a label assembly 10 in accordance with the present subject matter is illustrated. The label 10 comprises one or more relatively thin substrates collectively designated as 12, and one or more layers or regions of adhesive 14. The adhesive(s) 14 is described herein in greater detail, and is generally a radiation curable adhesive having characteristics enabling its use in cut and stack labeling applications. The substrate(s) 12 typically include one or more polymeric film materials however, may also include paper, paper-based materials, metallic films or foils, composite materials, and combinations thereof. The one or more substrate layers define an outermost face 16. A layer of adhesive 14 is typically disposed on a face of the substrate 12 opposite that of the outermost face 16. The exposed adhesive face 14 is designated as face 18, and in accordance with the present subject matter is typically free of a liner or other protective layer.

FIG. 2 is a perspective view of another representative label assembly 20 in accordance with the present subject matter. The label assembly 20 defines oppositely directed faces 36 and 38. Face 38 is typically an outer face of a polymeric film. Face 38 is an exposed face of an adhesive layer. As will be appreciated, in accordance with the present subject matter, the face 38 is free of a liner and thus the label 20 is typically referred to as “linerless.”

The term “transparent” when referring to one or more layers of the label means any material beneath such layers can be seen through such layers. In reference to the use of the “transparent” or “clear” labels applied to clear containers, such as beverage bottles, the bottle and the beverage within the bottle are visible through the label.

The term “clear” when referring to one or more layers of the label or to the label itself means the opacity of the layers or label is less than about 5%, and the layers or the label has a haze of less than about 10%. Opacity is measured in accordance with TAPPI Test T425 os, and haze is measured in accordance with ASTM Test Method D-1003.

The polymeric facestock may be a monolayer film or a multilayer film. The multilayer film may comprise from two to ten or more layers. The polymer facestock may be oriented or not oriented. The polymer facestock may be transparent or opaque. Opaque facestocks generally comprise a polymer as described below and one or more pigments to provide the facestock, or one layer of a multilayer facestock with the desired color. Pigments useful for this purpose are well known in the art. For example, white films can be prepared by introducing titanium dioxide and other white pigments into the polymer. Carbon black may be introduced to provide a black or grey facestock or film.

A wide variety of polymer film materials are useful in preparing the polymeric layers useful in the present subject matter. For example, the polymeric film material may include polymers and copolymers such as at least one polyolefin, polyacrylate, polystyrene, polyamide, polyvinyl alcohol, polyvinyl chloride, poly(alkylene acrylate), poly(ethylene vinyl alcohol), poly(alkylene vinyl acetate), polyurethane, polyacrylonitrile, polyester, polyester copolymer, fluoropolymer, polysulfone, polycarbonate, styrene-maleic anhydride copolymer, styrene-acrylonitrile copolymer, ionomers based on sodium or zinc salts of ethylene methacrylic acid, cellulosics, polyacrylonitrile, alkylene-vinyl acetate copolymer, or mixtures of two or more thereof. Nonlimiting examples of polyolefins that may be suitable for use in the present subject matter include polyethylene and polypropylene. Nonlimiting examples of polyesters that may be suitable include polyethylene terephthalate (PET). Oriented versions of any of the materials noted herein could be used such as for example bi-axially oriented polypropylene (BOPP). In certain versions of the present subject matter, the film material includes one or more of BOPP, polyethylene, polystyrene, PET, polycarbonate, and/or polyvinyl chloride. Combinations of these, and combinations with other materials are encompassed by the present subject matter.

The thickness of the polymeric films is typically within a range of from about 0.5 mil to about 10 mil, and particularly from 0.5 to 2 mils. However, the present subject matter includes films having thicknesses less than and/or greater than these thicknesses.

The present subject matter also provides a particular class of adhesives for use in association with the label assemblies, labeling systems, and related methods described herein. “Thiol-ene adhesives” as that term is used herein refers to adhesives comprising thiol-ene polymers prepared from the addition of a monomer or intermediate having a thiol group (—SH), referred to as a “thiol component” herein, with one or more alkenes. As will be appreciated, a thiol component is an organosulfur compound that contains a carbon-bonded sulfhydryl (—C—SH or R—SH) group (in which R represents an alkane, alkene, or other carbon-containing group of atoms). The —SH group is referred to as either a thiol group or a sulfhydryl group. A wide array of alkenes can be used such as allyl ethers, vinyl ethers, olefin alkenes, norbornenes, and combinations of these with other components.

In certain embodiments, the thiol-ene adhesives can be free of photoinitiators. In these embodiments, chromophores in the system absorb UV radiation and constitute at least a portion of the reaction site. Typical absorption wavelengths are centered around 254 nm. However, formation of a charge transfer complex can shift the wavelength(s) of absorption into UVB/UVA range.

In other embodiments, the thiol-ene adhesives include one or more photoinitiators or like agents. In particular embodiments, one or more agents are added for a specific purpose of absorbing UV radiation and initiating the reaction process. A portion of the photoinitiator is incorporated into the curing reaction, but the photoinitiator is a minor weight component of the cured network. The thiol-ene adhesives including photoinitiator(s) comprise photoinitiators added into the adhesive system as independent agents. The thiol-ene adhesives with photoinitiators may also comprise photoinitiators which are bound to the backbone or as a pendant structure of the thiol-ene polymer.

The thiol-ene polymers can be synthesized using a variety of techniques such as standard free radical polymerization, reversible addition-fragmentation chain transfer (RAFT) polymerization, and nitroxide mediated radical polymerization (NMP).

The thiol-ene adhesives can be cured by radiant energy such as by UV radiation or by electron beam. For ebeam curing, in many embodiments, it is not necessary to include photoinitiator(s). Additionally, in certain embodiments, all or a portion of the photoinitiator(s) can be replaced with a thermal free radical initiator. The present subject matter also includes adhesives curable and/or polymerizable upon exposure to radio frequency (RF) radiation (and so which typically include RF-activated agents). It is also contemplated that other factors and/or stimuli could be used to cure and/or polymerize the thiol-ene polymers described herein.

The thickness or coating weight of the adhesive layer is typically within a range of from about 5 gsm (grams per square meter) to about 100 gsm, and particularly from about 5 gsm to about 50 gsm. It will be appreciated that the present subject matter includes films having thicknesses less than and/or greater than these thicknesses.

The adhesive labels of the present subject matter may, and generally do contain other layers. For example, the label may contain a metal layer such as a film or foil that overlies and is in contact with a first polymeric layer. Alternatively, a print layer can be on the upper surface of polymeric layer.

In one embodiment, one of polymeric layers of the label comprises a polymeric ink layer. For example, a first polymeric layer may comprise a crosslinked ink that has been screen printed onto a second polymeric layer. Alternatively, the second polymeric layer may comprise an ink layer that has been printed onto the first polymeric layer.

In certain embodiments, a multilayer assembly having an interior core layer and one or more skin layers can be used. Examples of multilayer film facestocks which may be used in the present subject matter are described in U.S. Pat. No. 4,713,273. A multilayer web construction can be used and comprises a coextrudate including a core layer, a skin layer on the faces side of the coextrudate, and a skin layer on the inner side of the coextrudate opposite the face side.

The coextrudate and its layers comprise polymeric film materials, are formed by simultaneous extrusion from a suitable known type of coextrusion die, and are adhered to each other in a permanently combined state to provide a unitary coextrudate. The construction is used when the materials of the core and skins are such that these layers firmly adhere or bond to each other when coextruded as adjacent film layers. Tie layers can be used when the core and skin materials do not sufficiently adhere or bond to each other when they are extruded together.

Materials for skin and core layers may comprise physical blends of (1) polypropylene, polyethylene, their copolymers, or blends thereof and (2) ethylene vinyl acetate (EVA) in weight ratios ranging from 50/50 to 90/10.

Another material for the core or skin layers is polyethylene of low, medium or high density between about 0.915 and 0.965 specific gravity.

Inorganic fillers may be used to provide opaque film label stock. Useful fillers include calcium carbonate, titanium dioxide and blends thereof.

In certain embodiments, a particular material for the core layer for clear film label applications is a physical blend of (1) a copolymer of polypropylene and polyethylene and (2) ethylene vinyl acetate (EVA). For opaque film label applications, a particular core layer is a physical blend of polypropylene and EVA, filled with a mixture of calcium carbonate and titanium dioxide.

In certain embodiments, a material for the skin layers is a physical blend of polypropylene and EVA for both clear and opaque label film applications. Another material for the skin layers is polyethylene vinyl acetate. The skin layers may be identical or differ in composition. For example, polyethylene vinyl acetate might be the material used for the outer skin, but polyethylene acrylic acid might be used for the inner skin for better anchorage to, for example, an acrylic adhesive of choice.

Other materials for the skin layers include meltable film-forming substances used alone or in combination, such as polyethylene, polyethylene methyl acrylic acid, polyethylene ethyl acrylate, polyethylene methyl acrylate, acrylonitrile butadiene styrene polymer, polyethylene vinyl alcohol, nylon, polybutylene, polystyrene, polyurethane, polysulfone, polyvinylidene chloride, polypropylene, polycarbonate, polymethyl pentene, styrene maleic anhydride polymer, styrene acrylonitrile polymer, ionomers based on sodium or zinc salts of ethylene/methacrylic acid, polymethyl methacrylates, cellulosics, fluoroplastics, polyacylonitriles, and thermoplastic polyesters.

The present subject matter provides a wide array of label assemblies and multilayer laminates. Nonlimiting examples include liner backed, pressure sensitive adhesive laminates; self wound pressure sensitive adhesive laminates; film to film laminates; film to foil laminates; and film to paper laminates. The label assemblies and multilayer laminates can be provided in various forms such as but not limited to wound rolls and sheets of various dimensions.

### Labeling Systems and Methods

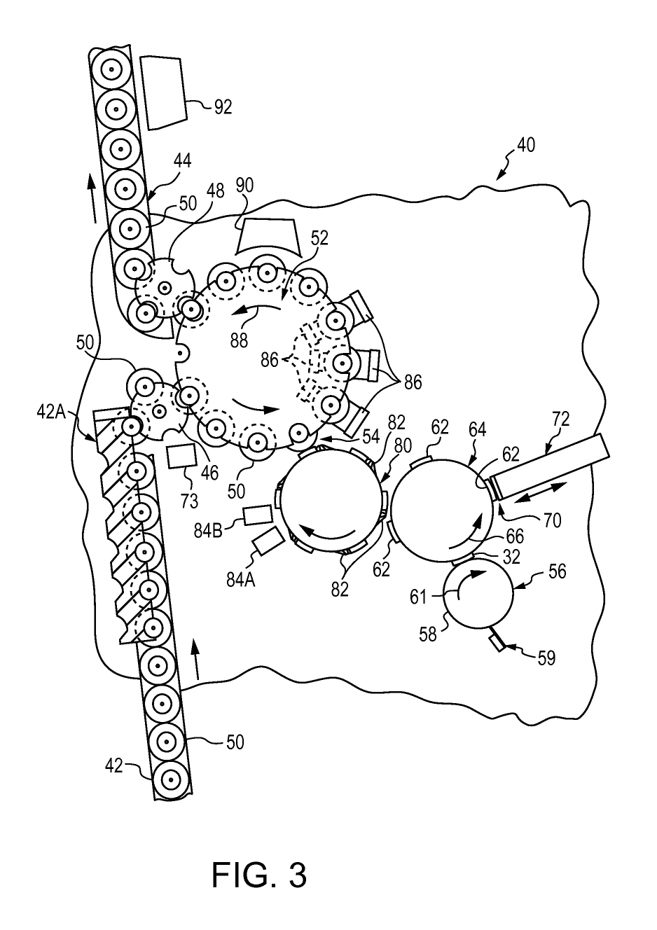

FIG. 3 illustrates a representative method and system for applying labels to containers in accordance with the present subject matter, and generally designated as 40. Although many embodiments of the present subject matter employ an adhesive curable by radiation with ultraviolet light, i.e., a UV curable adhesive, in accordance with the broadest aspects of the present subject matter other radiation curable adhesives may be employed, e.g., adhesives curable by radio frequency radiation or electron beam radiation. For embodiments of the present subject matter employing a radiation curing step after a label has been applied to a container, electron beam radiation may be a particular form of radiation.

A system 40 in accordance with the present subject matter comprises an inlet conveyor section 42, an outlet conveyor section 44, and rotating bottle-transfer members 46 and 48 for transferring bottles 50 from the inlet conveyor section to a rotating turret 52, and for removing bottles from the rotating turret to the exit conveyor section 44, respectively, after the bottles have been directed through label application station 54. However, it is within the scope of the present subject matter to utilize an in-line system that does not require the use of a rotating turret to handle the bottles, or other containers, during the label application operation.

The configuration of the inlet conveyor section 42, outlet conveyor section 44, rotating bottle-transfer members 46 and 48 and rotating turret 52 are all of a conventional design employed in commercially available labeling systems and methods. For example, KRONES manufactures a line of rotary labeling equipment including an inlet conveyor section 42, an outlet conveyor section 44, rotating bottle-transfer members 46 and 48 and a rotating turret 52 of the type that can be employed in the present subject matter. Therefore, a detailed discussion of these features is not required herein. KRONES AG is located in West Germany or KRONES, Inc. in Franklin Wis. (Krones AG and Krones, Inc. herein collectively being referred to as “KRONES”).

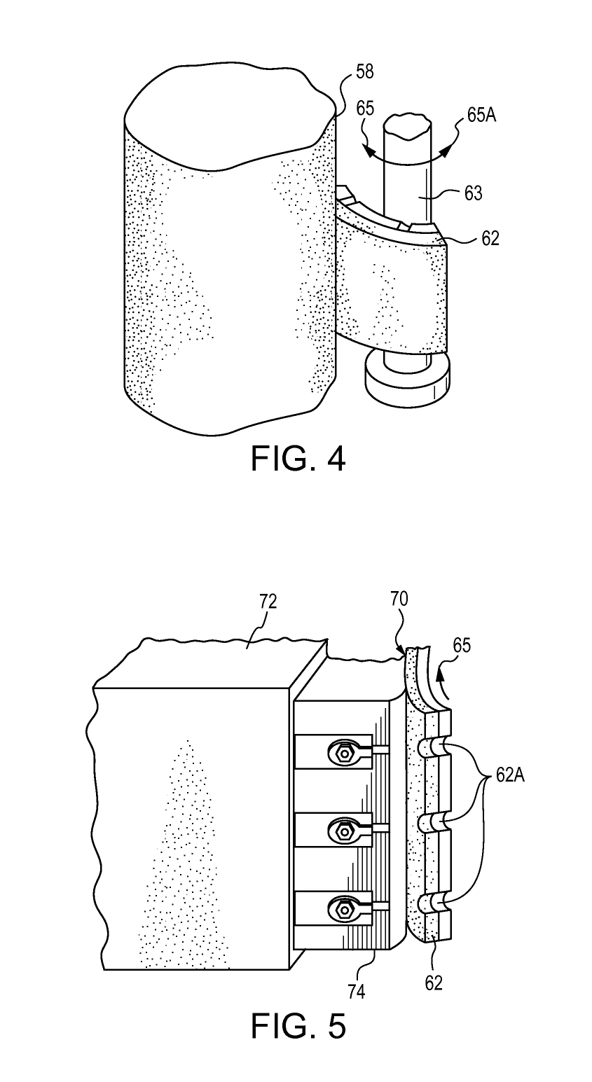

Referring specifically to FIGS. 3 and 4, in a particular method and system of the present subject matter, an adhesive application station 56 that includes a gravure or anilox applicator roll 58 of the type that generally is used in gravure or flexographic printing systems, respectively. This roll has a sufficient surface hardness to avoid the creation of imperfections therein, and sufficient release properties to release the adhesive carried thereby to transfer pads 62, which typically have smooth outer surfaces, for subsequent application from those pads to a label, as will be described in greater detail herein. Particularly, the transfer pads include an outer, elastomeric member, e.g., rubber or photo polymer material.

The gravure or anilox applicator roll 58 particularly is employed with a doctor blade 59 of conventional design, which may be of an enclosed type, and with adjustments to allow it to be placed in contact the surface of the gravure or anilox roll, or to be raised a desired distance away from it. In a particular form of the present subject matter, the adhesive is circulated from an adhesive supply chamber positioned below the vertically mounted applicator roll 58 through a suitable conduit to the outer surface of the roll adjacent the upper axial end thereof. The adhesive flows down the surface of the roll 58 as the roll is being rotated in the direction of arrow 61, filling the cells therein and actually applying a coating that extends beyond the surface of the roll. Adhesive that does not adhere to the roll is collected in a base section in which the roll is mounted and flows through a return conduit to the adhesive supply chamber to be recirculated. This type of system is well known for use with cold glue adhesives and therefore no further explanation is believed to be necessary in order to enable a person skilled in the art to practice the present subject matter.

It also should be noted that other systems, such as spray or slot-die application systems, can be employed to direct a controlled, metered layer of adhesive directly onto the surface of the transfer pads 62. When the adhesive is directed in a controlled, metered flow from a spray or slot-die application system, the surface of the transfer pad 62 for receiving that flow can be smooth, since that surface does not need to provide an independent metering function. However, if desired the adhesive-receiving surface of the transfer pad can include adhesive-receiving cells therein. Moreover, if the surface of each of the transfer pads for receiving adhesive does include adhesive-receiving cells therein, a smooth surfaced transfer roll possibly can be employed in place of a gravure or anilox roll, with the desired, or required, metered transfer onto the transfer pads being provided by the adhesive-receiving cells therein. Although the particular arrangement of the applicator roll 58 is in a non-pressurized environment, it is within the broadest scope of the present subject matter to employ a pressurized system, if desired.

Within the scope of the present subject matter the doctor blade 59 is disposed adjacent the surface of the roll with a preferred gap of 2-4 mils, to effectively provide a coating of a controlled thickness of the adhesive layer that, subsequent to passing the doctor blade 59, is applied to the surface of transfer pads 62. A particular configuration for the doctor blade 59 is a precision ground single blade wiper with an adjustable pitch, although other doctoring systems can be employed within the broadest aspects of the present subject matter. In certain embodiments of the subject matter, the doctor blade 59 is positioned in contact with the roll surface to essentially meter all the adhesive off the roll except for the adhesive retained within the cells in the roll surface. In a representative embodiment of the subject matter, the roll 58 is a ceramic engraved roll having quad cells present in a concentration of about 75 cells per inch. For certain applications, it may be suitable to utilize, as the applicator roll 58, a plain rubber roll. Therefore, in accordance with the broadest aspects of the present subject matter, the applicator roll need not include cells for receiving adhesive therein.

In certain embodiments of the present subject matter, the surface material or coating, the cell size and concentration in the surface of the gravure or anilox roll 58 and the position of the doctor blade 59 are selected to carry a sufficient quantity of adhesive to provide the desired adhesive coat weight on the labels. When utilized to adhere clear labels to clear containers, the coat weight on the labels is typically at least 6 pounds per ream and more particularly in a range of 7 to 8 pounds per ream or greater. However, the coat weight applied to the labels should not be so high as to result in excessive adhesive run-off from the transfer pads 62 to which the adhesive initially is applied. The coat weight applied to clear labels should provide a sufficient thickness to permit cold flow of the adhesive when the label is on the container or bottle to cause the adhesive to fill in unsightly striations or other adhesive imperfections that initially may exist when the label is adhered to the container. In a representative embodiment of the present subject matter, the thickness of the adhesive layer on the clear label, prior to applying the label to a container, is in he range of 0.5 to 1 mils and particularly does not exceed 1.5 mils.

It should be understood that the adhesive does not need to have a thickness on the label of 1 or more mils to provide the desired degree of tack to adhere the label to the container. This thickness is desired to permit cold flow of the adhesive after the label is adhered to a container to permit the adhesive to fill in unsightly striations in the circumferential direction, or other unsightly adhesive imperfections, a feature that in certain embodiments is desirable when applying clear labels to containers.

For applications involving adhering opaque labels to a container, the target basis weight of the adhesive coat applied to the label is approximately 2.5 pounds per ream, but can be higher, or lower, as is determined to be necessary to achieve the desired bond strength between the label and container. Although the adhesive may not cold flow to fill in gaps in the adhesive layer, this generally will not create an unacceptable appearance in opaque labels.

Referring further to FIG. 3, the gravure or anilox applicator roll 58 is driven in the direction of arrow 61, past the doctor blade 59. Thus, the exposed outer surface of the gravure or anilox applicator roll 58 receives a metered amount of UV curable adhesive on its surface, which is then engaged by the outer exposed surfaces of the transfer pads 62 disposed about the periphery of a rotating support member 64 that is rotated in the direction of arrow 66.

Referring specifically to FIG. 4, it should be noted that each of the transfer pads 62, the surface of which can be formed from rubber or other suitable material, e.g., a photopolymer of the type used in a flexographic system, is mounted on the rotating support member 64 through a support shaft 63 mounted for oscillatory motion relative to the support member, as represented by the arrow heads 65 and 65A. This oscillatory motion is provided by a cam drive arrangement that is well known to those skilled in the art, and is one that actually is employed in conventional cut and stack or sheet fed labeling systems, for example manufactured by KRONES.

The transfer pads 62 are typically formed of a smooth surfaced elastomer (natural or synthetic) having a Shore A hardness in the range of about 50 to about 90. This elastomer has been determined to provide good final adhesive visual properties when employed to adhere clear labels to a container or bottle.

In particular embodiments of the present subject matter, the transfer pads 62 are oscillated in the counterclockwise direction of arrow 65A, as viewed in FIG. 3, as each pad is moved in contact with the gravure roll 58 by rotation of the support member 64, to thereby cause the UV curable adhesive on the gravure roll to be applied substantially uniformly to each transfer pad.

Referring to FIGS. 3 and 5, the transfer pads 62, with the UV curable adhesive thereon, are then directed sequentially by the rotating member 64 to a transfer station 70. The transfer station 70 includes a magazine 72 retaining a stack of cut labels 74 therein. This magazine 72 is mounted for linear reciprocating motion toward and away from the exposed surface of the transfer pads, respectively, as is well known in the art. The linear reciprocating movement of the magazine 72 is controlled by a conventional photodetection system 73 positioned to detect the presence of a container at a specified location, particularly at the downstream end of helical feed roll 42A, of the inlet conveyor 42, as is known in the art. If a container is detected at the specified location on the inlet conveyor 42, the magazine 72 will be moved into, or maintained in a forward position for permitting a desired transfer pad 62 to engage and remove the lowermost label from the stack of cut labels 74 retained in the magazine. The desired transfer pad 62 is the one that receives a label that ultimately will be aligned with the detected container when that container is in label applicator section 54 of the rotating turret 52, to thereby transfer, or apply, the label to the container, as will be described in detail herein. If a container is not detected at the specified location by the photodetection system 73, then the magazine 72 will be retracted to preclude a predetermined transfer pad 62 from engaging and receiving the lowermost label in the magazine 74, which label ultimately would have been directed to an empty container position at the label applicator section 54 on the turret 52 resulting from a container not being in the specified location being monitored by the photodetection system.

Still referring to FIGS. 3, 4, and 5, when a transfer pad 62 is in a position aligned for engaging the lowermost label 74 carried in the magazine 72, that pad is oscillated in the clockwise direction of arrow 65, as viewed in FIG. 4, for engaging the lowermost label 74 in the magazine 72 to both apply the adhesive to that label and remove that label from the stack through surface adhesion with the minimally tacky adhesive.

The mechanical systems employing the oscillatory transfer pad 62 and the reciprocal magazine 72 are known in the art, being employed in commercially available cut and stack label applying systems manufactured, for example, by KRONES. Therefore, for purposes of brevity, details of construction of these systems are omitted.

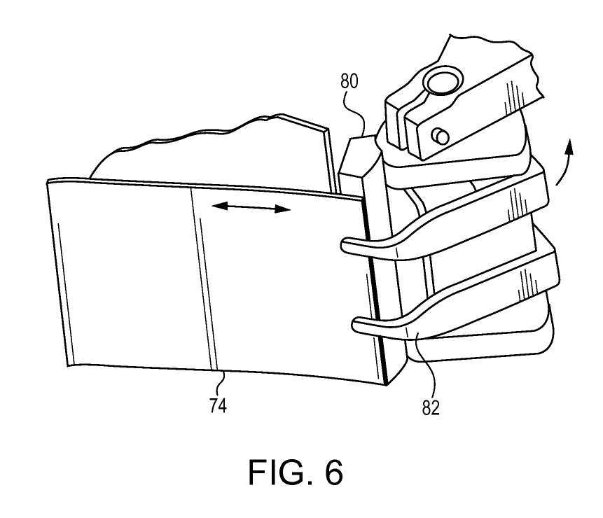

Referring to FIGS. 3 and 6, the transfer pads 62, with the labels thereon, are then rotated by the support member 64 to a transfer assembly shown generally at 80. This transfer assembly includes a plurality of cam operated gripping members 82 disposed about the periphery thereof for engaging labels 74 carried by the transfer pads 62 and transferring the labels to the transfer assembly 80. The transfer assembly 80 is of a conventional design, and therefore the details of this assembly, including the cam operation of the gripping members 82 is omitted, for purposes of brevity. Generally, the gripping members 82 engage the labels 74 carried on the transfer pads 62 in the regions of the labels aligned with cut-outs 62A in the transfer pads 62, as is best illustrated in FIGS. 4 and 5. During transfer of the labels to the transfer assembly 80 the pads 62 are oscillated in the counterclockwise direction of arrow 65A, as depicted in FIG. 3.

Referring further to FIG. 3, in accordance with the present subject matter, the rotary transfer assembly 80, with labels 74 thereon, can be directed through an irradiating section in the form of a UV cure section, which can be the same or similar as the UV cure section disclosed in U.S. Pat. No. 6,517,661 when the containers with the labels thereon are subjected to one or more subsequent curing steps, as will be described in greater detail herein. Moreover, in accordance with the present subject matter, when one or more curing steps are provided after the label has been attached to the container, it may not be necessary to provide any cure section for curing the adhesive on the label prior to application of the label on the container.

Alternatively, the UV cure station can include a multi-lamp system, such as one employing separate lamps 84A and/or 84B that emit UV radiation of different wavelengths to provide, respectively, the primary curing action in the interior region of the adhesive layer, followed by a cure focused primarily at the exposed surface of the adhesive layer. When using this latter, multi-lamp system, it may not be necessary to provide a subsequent cure step after the label has been applied to the container. However, it is within the scope of this aspect of the present subject matter to provide one more curing operations after the label is attached to the container, if needed.

In an exemplary embodiment of the subject matter, the lamp 84A of the cure station employs an iron-doped metal halide bulb (type D) that emits UV radiation in the wavelength range of 350-450 nanometers to effect a primary curing action in the interior region of the adhesive layer, and the lamp 84B employs a mercury vapor bulb (type H) that emits UV radiation in the wavelength range of 250-350 nanometers to effect a primary curing action at the exposed surface of the adhesive layer.

If desired, additional lamps can be employed to increase the power output, thereby permitting the equipment to operate at higher speeds, or, if desired, to provide different radiation spectra, as desired. In certain embodiments, the system is used with a third lamp following lamp 84B, which employs an iron-doped metal halide bulb identical to that employed in the lamp 84A. This enhances the power output and also provides additional curing of the adhesive, principally in the interior region thereof.

The specific power output required of each of the lamps depends, among other factors, upon the cure rate of the specific UV curable adhesive employed and the speed of operation of the labeling equipment. The degree of cure of the adhesive is most effectively controlled by controlling the total amount of radiation of appropriate wavelength that is delivered to the adhesive. The factors affecting the total amount of radiation of appropriate wavelength delivered to the adhesive are (1) residence time of the adhesive in the light, (2) wavelength match between the adhesive and the light source, (3) distance from the light source to the adhesive, (4) intensity of the light source and (5) use of filters, absorbers or attenuators. In accordance with the present subject matter, the use of two separate bulbs to emit UV radiation of different wavelengths for the purposes described herein provides for more efficient partial curing of the adhesive than employing only a single bulb. This enables the processing equipment to be effectively run at higher speeds. Also, as previously explained, enhanced power is provided by the inclusion of additional bulbs, and a third lamp system employing a bulb identical to that employed in the lamp system 84A presently is also contemplated.

In an exemplary embodiment, the lamps 84A and 84B each provide a 600 watt per inch output, which provides sufficient intensity to cure both the interior and surface regions of the adhesive layer; which, as previously noted, in certain embodiments is applied to the label film substrate at a coating thickness in the range of 0.5 to 1.0 mils, at film throughput speeds greater than 500 bottles per minute when clear plastic labels are being applied to the containers. In accordance with a particular version of the present subject matter, at least two 600 watt per inch bulbs are utilized to provide the desired power to cure the adhesive at speeds greater than 500 bottles/minute for clear plastic labels. As previously noted, at present three bulbs can be employed, each having a power output of 600 watts per inch.

It should be understood that in a particular embodiment of the present subject matter, the UV curable adhesive is in a minimally tacky state until it passes through the UV cure station including lamps 84A, 84B and a third lamp (not shown) identical to lamp 84A. Thus, in accordance with the present subject matter, the systems and methods are employed without the need to handle an excessively tacky adhesive material throughout the entire processing operation. The UV curable adhesive is only rendered sufficiently tacky to permit the label to be effectively adhered to the outer surface of a container at a location closely adjacent the label application station 54.

Particular UV curable adhesives usable in the present subject matter also are of a sufficiently low viscosity to permit the adhesive to be applied substantially uniformly over a label surface. Generally, the viscosity of the adhesives usable in the present subject matter is in the range of about 500 to about 10,000 centipoises; more particularly under 5,000 centipoises; still more particularly in the range of about 1,000 to about 4,000 centipoises and most particularly in the range of 2,000 to 3,000 centipoises.

UV curable adhesives typically comprise one or more free radical or cationic initiators and monomers which are polymerizable via these mechanisms. In accordance with the present subject matter all of the above types of UV curable adhesives can be employed. UV curable adhesives are available form a variety of sources, e.g., H. B. Fuller, National Starch, Henkel, and Craig Adhesives & Coatings Company of Newark, N.J.

In certain embodiments, it is useful to utilize an adhesive employing a combination of both free-radical and cationic initiators. Such an adhesive is available from Craig Adhesives & Coatings Company under the designation Craig C 1029 HYB UV pressure sensitive adhesive. This latter adhesive has a viscosity of approximately 2,500 centipoises. It should be noted that UV adhesives employing free-radical initiators have a relatively strong initial cure but provide a poor visual appearance. On the other hand, UV adhesives employing cationic initiators provide weak initial cure but have good visual appearance. By employing a UV curable adhesive including a blend of these two types of initiators excellent results can be achieved. It is believed that the noted Craig pressure sensitive adhesive may exhibit problems when used to adhere labels to wet bottles. In particular, this adhesive has a surfactant that tends to absorb water from the bottle, which adversely affects the appearance of the adhesive, which can be seen through clear labels.

A representative UV curable adhesive system can have a free radical adhesive system that preferably has a low surface tension of 34 dynes or less and may comprise a range of acrylic monomers with a glass transition temperature (Tg) in the range of −80° C. to 100° C. that are blended to optimize the adhesive performance (i.e., tack) based on the temperature conditions at which the label is being adhered to the container. In certain embodiments, the adhesive system may also include additional flowable components, which may or may not subsequently be dark cured, so as to adjust the aesthetic properties of the adhesive by flowing to fill in striations and other imperfections in the adhesive layer, after the label has been applied to the container. Exemplary flowable components are cationically polymerizable epoxy resins that are polymerized through a cationic initiator included in the adhesive system.

With further reference to FIG. 3, each of the labels 74 is directed from the UV cure station with the adhesive thereon being in at least a partially cured, sufficiently tacky condition to uniformly and effectively adhere the label to a container, and the label is then immediately rotated into a position for engaging the outer periphery of a bottle 50 carried on the turret 52 in the label application station 54. It should be noted that the spacing of the labels on the transfer assembly 80 and the speed of rotation of the transfer assembly are timed with the speed of rotation of the rotating turret 52 such that each label carried on the transfer assembly 80 is sequentially directed into engagement with an adjacent bottle carried on the rotating turret. Moreover, the photodetection system 73 prevents a label from being carried to the label application station 54 when a bottle for receiving such label is missing from that station.

Still referring to FIG. 3, each of the labels 74 is applied essentially at its midline to the periphery of an adjacent bottle 50, thereby providing outer wings extending in opposed directions from the center line of the label, which is adhered to the bottle. This manner of applying a label to a bottle is conventional and is employed in rotary labeling equipment, for example manufactured by KRONES. However, in accordance with the broadest aspects of the present subject matter, the labels can be applied to the outer surface of the bottles in other fashions.

After a label 74 initially is adhered to a bottle 50 in the label application station 54, the rotating turret 52 directs each bottle, with the label attached thereto, through a series of opposed inner and outer brushes 86. As the bottles are directed through the series of brushes the bottles are also oscillated back and forth about their central axis to thereby create an interaction between the bottles, labels and brushes to effectively adhere the entire label to the periphery of each bottle. This brush arrangement and the system for oscillating the bottles as they move past the brushes are of a conventional design and are well known to those skilled in the art. Such a system is included in labeling equipment employing cold glue, for example labeling equipment manufactured by KRONES.

Still referring to FIG. 3, after the labels 74 have been adhered to the bottles 50, the bottles may be carried by the rotating turret in the direction of arrow 88 through a subsequent radiation station 90, if necessary, to enhance curing of the adhesive for achieving effective, permanent adherence of the label on the container. This radiation station 90 can include the same type of bulb, or bulbs, for emitting UV radiation in a desired wavelength spectra, or alternatively can employ at least two different type bulbs to emit UV radiation in more than one wavelength spectra to enhance the curing in different regions through the thickness of the adhesive layer. As previously noted, when a UV cure station 90 is employed after the label is attached to the container, it may be possible to omit the use of a UV cure station (either single type, or multiple type bulbs) to partially cure the adhesive on the label prior to applying the label to the container. However, in accordance with the present subject matter, when no UV cure station is employed after the label is attached to the container, the UV cure station employed to either partially or fully cure the adhesive on the label prior to applying the label to the container is a multi-bulb station employing bulbs that emit UV radiation of different wavelengths, as previously described herein.

Still referring to FIG. 3, after the labels 74 have been effectively adhered to the bottles 50, the bottles are carried by the rotating turret 52 in the direction of arrow 88 to the bottle-transfer member 48, at which the bottles are transferred to the outlet conveyor section 44 for subsequent packaging. As shown, a UV cure station 92 can be employed adjacent the outlet conveyor section 44 for curing the adhesive on the label attached to the container. This UV cure station can be in lieu of, or in addition to the UV cure station 90. Moreover, the UV cure station 92, like the UV cure station 90, can include the same type of bulb, or bulbs, for emitting UV radiation in a single, desired wavelength range, or alternatively can employ at least two different type bulbs to emit UV radiation in more than one wavelength range to enhance the curing in different regions through the thickness of the adhesive layer.

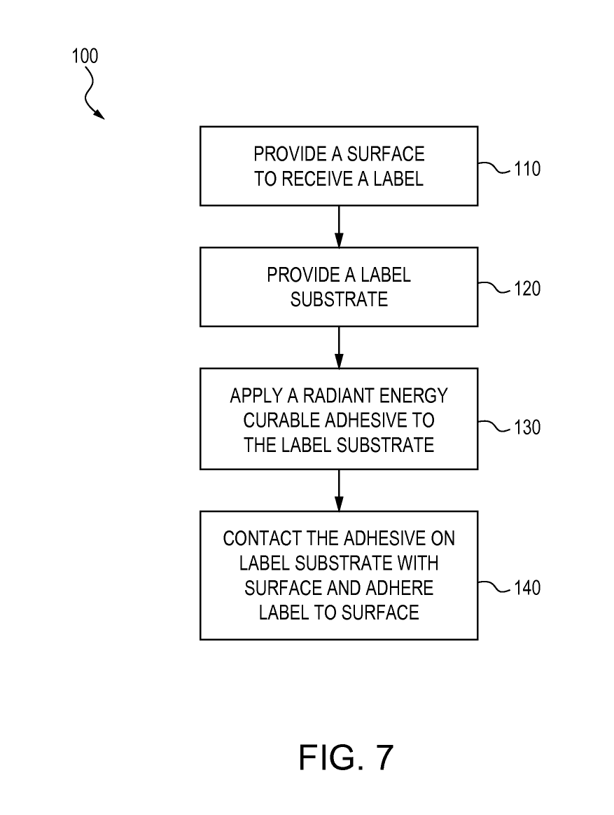

FIG. 7 is a schematic flowchart illustrating a method 100 in accordance with the present subject matter. The method 100 comprises one or more operations 110 of providing a surface to receive a label. Nonlimiting examples of such surfaces include surfaces of containers such as beverage bottles and food containers. However, the present subject matter includes a host of other surfaces including consumer products, packaging, and industrial article containers and packages. The method 100 also comprises one or more operations 120 of providing a label substrate. The label substrate can take a variety of different forms and include any of the materials and configurations noted herein. The method 100 also comprises one or more operations 130 of applying a radiant energy curable adhesive to the label substrate. The adhesive is curable by any of the forms of radiant energy described herein such as for example UV radiation. The application of the adhesive is performed by techniques known in the art and/or as described herein. The adhesive composition is such that the adhesive is curable upon exposure to radiant energy as described herein. In certain embodiments, the adhesive is a thiol-ene adhesive as described herein. The method 100 also comprises one or more operations 140 of contacting the adhesive on the label substrate with the noted surface and adhering the label to the surface.

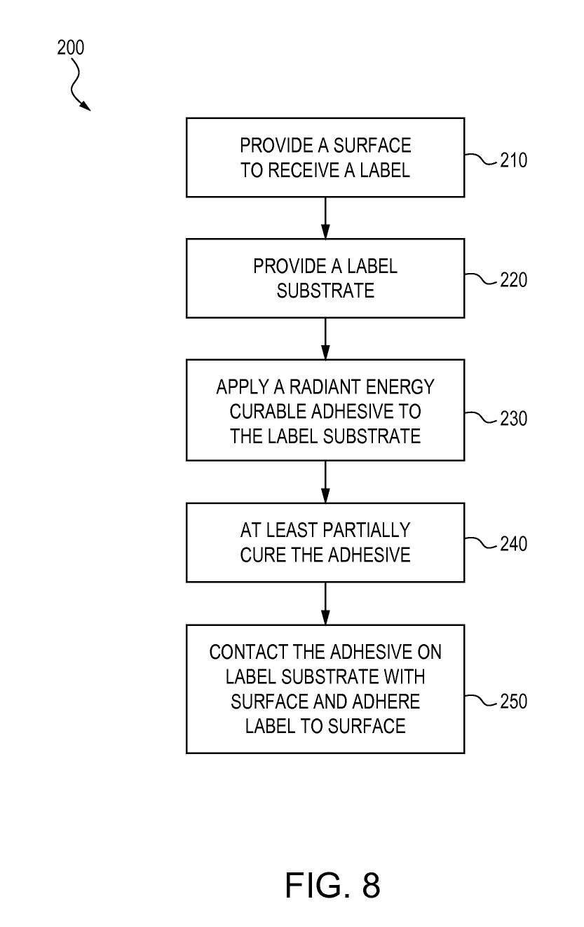

FIG. 8 is a schematic flowchart illustrating another method 200 in accordance with the present subject matter. The method 200 comprises one or more operations 210 of providing a surface to receive a label. Nonlimiting examples of such surfaces include surfaces of containers such as beverage bottles and food containers. However, the present subject matter includes a host of other surfaces including consumer products, packaging, and industrial article containers and packages. The method 200 also comprises one or more operations 220 of providing a label substrate. The label substrate can take a variety of different forms and include any of the materials and configurations noted herein. The method 200 also comprises one or more operations 230 of applying a radiant energy curable adhesive to the label substrate. The adhesive is curable by any of the forms of radiant energy described herein such as for example UV radiation. The application of the adhesive is performed by techniques known in the art and/or as described herein. The adhesive composition is such that the adhesive is curable upon exposure to radiant energy as described herein. In certain embodiments, the adhesive is a thiol-ene adhesive as described herein. The method 200 additionally comprises one or more operations 240 of at least partially curing the adhesive. Curing or partial curing can be performed by any of the techniques described herein or known in the art. The method 200 also comprises one or more operations 250 of contacting the adhesive on the label substrate with the noted surface and adhering the label to the surface.

It should be understood that the UV curable adhesives that are employed in many embodiments of the present subject matter are in a minimally tacky, low viscosity state until they are exposed to UV radiation. Thus, as previously noted herein, the systems and methods of the present subject matter are not required to handle an excessively tacky adhesive throughout the majority of the process. This provides for a cleaner running operation.

Moreover, UV curable adhesives are extremely well suited for use with clear labels since they are applied as a clear coating that does not detract from the clarity of the film. This permits clear films to be adhered to clear bottles to provide a highly attractive labeled product. Moreover, in particular embodiments, a UV curable adhesive, which is a blend of both free-radical and cationic initiators, exhibits cold flow after the label is applied to the container, to thereby fill in unsightly striations that are formed in the circumferential direction of the label, as well as other unsightly adhesive imperfections.

However, it should be noted that UV radiation may not be the most desirable system to use for curing the adhesive through the label, which is the manner of curing employed after the label is secured to the container. In this latter system, an e-beam curable adhesive may be more desirable. In such case, the cure station(s) located downstream of the station at which the label is applied to the container will be an e-beam cure station(s).

The use of thiol-ene adhesives as described herein can in certain embodiments provide one or more of the following benefits: (i) less sensitivity to oxygen inhibition; (ii) thicker films can be cured at the same line speed with less photoinitiator; (iii) thicker films can be cured faster with conventional levels of photoinitiator; (iv) inclusion of the thiol group into the polymer of the adhesive provides improved application for food contact situations; (v) chemistries typically not used in UV free radical polymerization can be utilized such as for example allyl ethers, vinyl ethers, undifferentiated olefins; and (vi) the use of adhesives free of photoinitiators.

Although the UV curable pressure sensitive adhesives of the present subject matter have been primarily described as thiol-ene types, it will be understood that the present subject matter is not limited to such. For example, a UV curable pressure sensitive adhesive having a low viscosity (i.e., “syrups”) for printing, fast UV cure, and adequate adhesive performance could be used in certain applications. Such adhesives are described in U.S. Pat. No. 6,677,402, col. 13.

Moreover, although the present subject matter has been primarily described in terms of cut and stack labeling applications, it will be understood that the present subject matter includes other applications. For example, it is contemplated that the present subject matter could also find application in in-line print, die cut, adhesive application, and/or label apply operation.

Furthermore, the present subject matter has wide application in a variety of different markets and industries. Non-limiting examples of such include labels and packaging for direct food contact and also for indirect food contact. Another prime application of the present subject matter is in thick films and industrial tapes. It will be understood that the present subject matter is not limited to any of these applications.

Many other benefits will no doubt become apparent from future application and development of this technology.

All patents, published applications, and articles noted herein are hereby incorporated by reference in their entirety.

As described hereinabove, the present subject matter solves many problems associated with previous strategies, systems and/or devices. However, it will be appreciated that various changes in the details, materials and arrangements of components, which have been herein described and illustrated in order to explain the nature of the present subject matter, may be made by those skilled in the art without departing from the principle and scope of the claimed subject matter, as expressed in the appended claims.

What is claimed is:

1. A label assembly comprising:
a substrate defining a first face and a second oppositely directed face;
a layer of a thiol-ene adhesive disposed on at least one of the first face and the second face of the substrate.

2. The label assembly of claim 1 wherein the label assembly is free of a liner.

3. The label assembly of claim 1 wherein the thiol-ene adhesive is curable upon sufficient exposure to radiant energy.

4. The label assembly of claim 3 wherein the radiant energy is selected from the group consisting of UV radiation, electron beam, RF radiation, and combinations thereof.

5. The label assembly of claim 4 wherein the radiant energy is UV radiation.

6. The label assembly of claim 1 wherein the substrate is selected from the group consisting of polymeric film materials, paper, paper-based materials, metallic films or foils, composite materials, and combinations thereof.

7. The label assembly of claim 6 wherein the substrate is a polymeric film material.

8. The label assembly of claim 7 wherein the polymeric film material is selected from the group consisting of polypropylene, polyethylene, polystyrene, polyethylene terephthalate, polycarbonate, polyvinyl chloride, and combinations thereof.

9. The label assembly of claim 8 wherein the polypropylene is bi-axially oriented polypropylene.

10. The label assembly of claim 1 wherein the thiol-ene adhesive comprises one or more thiol-ene polymers prepared from the addition of a thiol component having a thiol group with one or more alkenes.

11. The label assembly of claim 10 wherein the thiol component is an organosulfur compound that contains a carbon-bonded sulfhydryl group.

12. The label assembly of claim 10 wherein the alkene is selected from the group consisting of allyl ethers, vinyl ethers, olefin alkenes, norbornenes, and combinations thereof.

13. The label assembly of claim 1 wherein the thiol-ene adhesive is free of photoinitiators.

14. The label assembly of claim 1 wherein the thiol-ene adhesive includes one or more photoinitiators.

15. The label assembly of claim 1 further comprising at least one additional layer or region selected from the group consisting of a metal film or foil layer, a print layer, a polymeric ink layer, an interior core layer, one or more skin layers, and combinations thereof.

16. The label assembly of claim 1 wherein the substrate is a polymeric film layer and is transparent.

17. The label assembly of claim 1 wherein the label assembly is in the form of a wound roll.

18. A method of labeling a surface, the method comprising:
providing a surface to receive a label;
providing a label substrate, the label substrate defining a first face and an oppositely directed second face;
applying a thiol-ene adhesive to the first face of the label substrate to thereby form an adhesive layer on the label substrate, the adhesive layer defining an exposed adhesive face;
contacting the adhesive face with the surface and adhering the label substrate to the surface.

19. The method of claim 18 wherein prior to contacting the adhesive face with the surface, the adhesive face is exposed to radiant energy to enhance the tack of the adhesive prior to adhering the substrate to the surface.

20. The method of claim 18 further comprising:
post curing the adhesive after contacting the adhesive face with the surface.

21. The methods of claim 19 wherein the radiant energy is UV radiation.

22. A method of labeling a surface, the method comprising:
providing a surface to receive a label;
providing a label substrate, the label substrate defining a first face and an oppositely directed second face;
applying a thiol-ene adhesive to the first face of the label substrate to thereby form an adhesive layer on the label substrate, the adhesive layer defining an exposed adhesive face;
at least partially curing the adhesive;
contacting the adhesive face after at least partial cure with the surface;
adhering the label substrate to the surface.

23. The method of claim 22 wherein the at least partially curing of the adhesive is performed by exposing the adhesive to radiant energy.

24. The method of claim 23 wherein the radiant energy is UV radiation.
